(19) United States
(12) Patent Application Publication
(10) Pub. No.: US 2014/0311159 A1
(43) Pub. Date: Oct. 23, 2014

(54) VARIABLE NOZZLE MECHANISM

(71) Applicants: Hiroaki Ikegami, Toyota-shi (JP); Koichi Yonezawa, Toyota-shi (JP); Tsuyoshi Uesugi, Takahama-shi (JP); Manabu Ishikawa, Anjo-shi (JP)

(72) Inventors: Hiroaki Ikegami, Toyota-shi (JP); Koichi Yonezawa, Toyota-shi (JP); Tsuyoshi Uesugi, Takahama-shi (JP); Manabu Ishikawa, Anjo-shi (JP)

(73) Assignees: KABUSHIKI KAISHA TOYOTA JIDOSHOKKI, Kariya-shi, Aichi-ken (JP); TOYOTA JIDOSHA KABUSHIKI KAISHA, Toyota-shi, Aichi-ken (JP)

(21) Appl. No.: 14/358,385

(22) PCT Filed: Nov. 6, 2012
(86) PCT No.: PCT/IB2012/002243

§ 371 Date: May 15, 2014

(30) Foreign Application Priority Data
Nov. 16, 2011 (JP) 2011-250912

(51) Int. Cl. F02C 7/00

(52) U.S. Cl. CPC F02C 7/00
USPC 60/793

(57) ABSTRACT

A variable nozzle mechanism applied to a turbocharger includes a pair of annular plates located between a scroll passage and a turbine chamber such that the plates are apart from each other in a direction along an axis; a coupling portion which couples the plates; a plurality of variable nozzles which are provided between the plates so as to open and close, and which change a flow speed of exhaust gas blown onto a turbine wheel when an opening degree of the variable nozzles is changed; and an urging portion which urges the plates in the direction along the axis to press one of the plates against a contacted object. The one of the plates includes a contact face which is in contact with the contacted object, and the contact face is located on an action line along which an urging force of the urging portion acts.

### BACKGROUND OF THE INVENTION

1. Field of the Invention

The present invention relates to a variable nozzle mechanism for a turbocharger.

2. Description of the Related Art

A variable nozzle mechanism for a turbocharger of an engine is described in, for example, Japanese Patent Application Publication No. 2009-62840 (JP 2009-62840 A). In this turbocharger, a turbine shaft is rotatably supported by a bearing housing 71 that is shown in FIG. 4. A turbine housing 72 is located on one side (the right side in FIG. 4) of the bearing housing 71 in a direction along the axis of the turbine shaft. The turbine housing 72 has a turbine chamber 73 at its center and a scroll passage 75 with a scroll shape, which is formed around the turbine chamber 73. A turbine wheel (not shown) which rotates in the turbine chamber 73 is mounted on the turbine shaft. In the turbocharger 70, the exhaust gas which has been discharged from the engine and flowed through the scroll passage 75 is blown onto the turbine wheel so that the turbine wheel is rotatably driven. Then, a compressor wheel (not shown), which is provided on the shaft on which the turbine wheel is provided, is rotated together with the turbine wheel to perform supercharging (to compress intake air and feed it into the engine).

A variable nozzle mechanism 80 includes a pair of annular plates 81 and 82 which are located between the scroll passage 75 and the turbine chamber 73 to be apart from each other in a direction along the axis (the lateral direction of FIG. 4) and coupled by, for example, pins; and a plurality of variable nozzles 83 which are configured to open and close between the plates 81 and 82. The variable nozzle mechanism 80 changes the flow speed of the exhaust gas that is blown onto the turbine wheel by changing the opening of the variable nozzles 83. In addition, the variable nozzle mechanism 80 is urged in a direction from the bearing housing 71 toward the turbine housing 72 by a spring 84. The plate 81 on the bearing housing 71-side has a flange portion 81A provided along an outer periphery of the plate 81, and a flange portion 72A is provided in the turbine housing 72. The variable nozzle mechanism 80, which is urged by the spring 84, is pressed against the flange portion 72A of the turbine housing 72 at the flange portion 81 A of the plate 81. Because the variable nozzle mechanism 80 is thus pressed against the flange portion 72A, the variable nozzle mechanism 80 is positioned in a floating manner without being fixed to the housings 71 and 72.

In the variable nozzle mechanism 80 that is described in JP 2009-62840 A, however, a region P1 to which the urging force F1 of the spring 84 is applied and a region P2 (the flange portion 81A) in contact with the turbine housing 72 are far away from each other in the radial direction of the turbine shaft (the vertical direction of FIG. 4). Thus, because a force (moment), which acts to rotate the variable nozzle mechanism 80 about the flange portion 81A (as a fulcrum) that is in contact with the turbine housing 72, is applied to the variable nozzle mechanism 80 by the spring 84, a load which tends to deform the plate 81 is constantly applied to the plate 81. As a result, the plate 81 may undergo plastic deformation in, for example, high-temperature conditions where the material strength of the constituent parts of the variable nozzle mechanism 80 is reduced.

### SUMMARY OF THE INVENTION

The present invention provides a variable nozzle mechanism in which deformation of the plates is suppressed.

A first aspect of the invention relates to a variable nozzle mechanism which is applied to a turbocharger that includes a bearing housing by which a turbine shaft is rotatably supported; a turbine housing which is located on one side of the bearing housing in a direction along an axis of the turbine shaft and which includes a turbine chamber and a scroll passage provided around the turbine chamber; and a turbine wheel which is mounted on the turbine shaft and rotates in the turbine chamber of the turbine housing, wherein exhaust gas that has been discharged from an engine and flowed through the scroll passage is blown onto the turbine wheel so that the turbine wheel is rotated. The variable nozzle mechanism includes a pair of annular plates located between the scroll passage and the turbine chamber in a manner such that the plates are apart from each other in the direction along the axis; a coupling portion which couples the plates; a plurality of variable nozzles which are provided between the plates so as to open and close, and which change a flow speed of the exhaust gas blown onto the turbine wheel when an opening degree of the variable nozzles is changed; and an urging portion which urges the plates in the direction along the axis to press one of the plates against a contacted object. The one of the plates includes a contact face which is in contact with the contacted object, and the contact face is located on an action line along which an urging force of the urging portion acts.

According to the above configuration, the plates of the variable nozzle mechanism are urged in the direction along the axis of the turbine shaft and the one of the plates is pressed against the contacted object by the urging portion. Because the one of the plates is thus pressed against the contacted object, the plates are positioned in a floating manner without being fixed to the bearing housing or turbine housing.

In the above aspect, because the contact face, which is in contact with the contacted object, is provided on the action line along which the urging force of the urging portion acts, the distance in the radial direction of the turbine shaft between a region to which the urging force is applied and the region (contact face) which is in contact with the contacted object is “0” or close to 0. Thus, because a force (moment) which acts to rotate the variable nozzle mechanism about the region that is in contact with the contacted object is not or hardly applied to the variable nozzle mechanism by the urging portion, a load which tends to deform the plates is less likely to be applied to the plates. As a result, the plates are prevented from being deformed by the urging portion.

In the above-described aspect, the urging portion may be a spring. According to the above configuration, a spring made of an elastic material, such as a metal, is used as the urging portion. The spring is incorporated in the turbocharger in an elastically-deformed state with elastic energy stored in it. The plates are urged in the direction along the axis of the turbine shaft by a force of the spring which acts to release the elastic energy (elastic restoring force or urging force). Thus, it is possible to provide the urging portion with the simple structure that urges the plates in the direction along the axis.

In the above-described aspect, the spring may be a disc spring which is provided to surround the turbine wheel. According to the above configuration, because the disc spring is used as the urging portion, the plates are urged in the direction along the axis by a substantially equal urging force at any position in the circumferential direction. Thus, the one of the plates is pressed against the contacted object by a pressure force that is substantially equal at any position in the circumferential direction.

In the above-described aspect, the contacted object may be the bearing housing or the turbine housing.

According to the above configuration, the plates are urged in the direction along the axis of the turbine shaft by the urging portion, and the one of the plates is pressed against the bearing housing or the turbine housing. At this time, the region to which the urging force of the urging portion is applied in the variable nozzle mechanism, and the contact face with which the bearing housing or the turbine housing is in contact are both located on the action line along which the urging force of the urging portion acts. Because the distance in the radial direction of the turbine shaft between the region to which the urging force of the urging portion is applied and the contact face with which the bearing housing or the turbine housing is in contact is “0,” the plates are prevented from being deformed by the urging portion. Because the bearing housing or the turbine housing, which is an existing part of the turbocharger, is used as the contacted object as described above, there is no need to additionally provide a contacted object.

In the above-described aspect, the one of the plates may be located ahead of the other of the plates in an urging direction of the urging portion, the one of the plates may include a protrusion which protrudes forward in the urging direction, and an end face of the protrusion may constitute the contact face.

According to the above configuration, when the plates are urged in the direction along the axis of the turbine shaft by the urging portion, the plates are displaced forward in the urging direction. The protrusion, which is provided on the one of the plates that is located ahead of the other in the urging direction of the urging portion and protrudes forward in the urging direction, is also displaced in the same direction. The end face of the protrusion as the contact face is pressed against the contacted object.

The variable nozzle mechanism according to the above-described aspect may further include a spacer which is located between the plates and on the action line passing through the contact face, to maintain a distance between the plates.

According to the above configuration, the region to which the urging force of the urging portion is directly applied in the variable nozzle mechanism, the spacer between the plates, and the contact face that is in contact with the contacted object are all located on the action line along which the urging force of the urging portion acts. Thus, the urging force of the urging portion is efficiently transmitted to the contacted object along the action line via the region, the spacer and the contact face.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is partial sectional view that illustrates the schematic configuration of a turbocharger in which a variable nozzle mechanism according to an embodiment of the present invention is incorporated;

FIGS. 2A and 2B are diagrams that illustrate a part of the variable nozzle mechanism according to the embodiment, FIG. 2A being a side elevation as seen from the left side of FIG. 1 and FIG. 2B being a side elevation as seen from a right side of FIG. 1;

FIG. 3 is an enlarged partial sectional view that illustrates the sectional structure of the variable nozzle mechanism according to the embodiment and peripheral parts around the variable nozzle mechanism, in a section different from that of FIG. 1; and

FIG. 4 is an enlarged partial sectional view that illustrates a main part of a variable nozzle mechanism in related art.

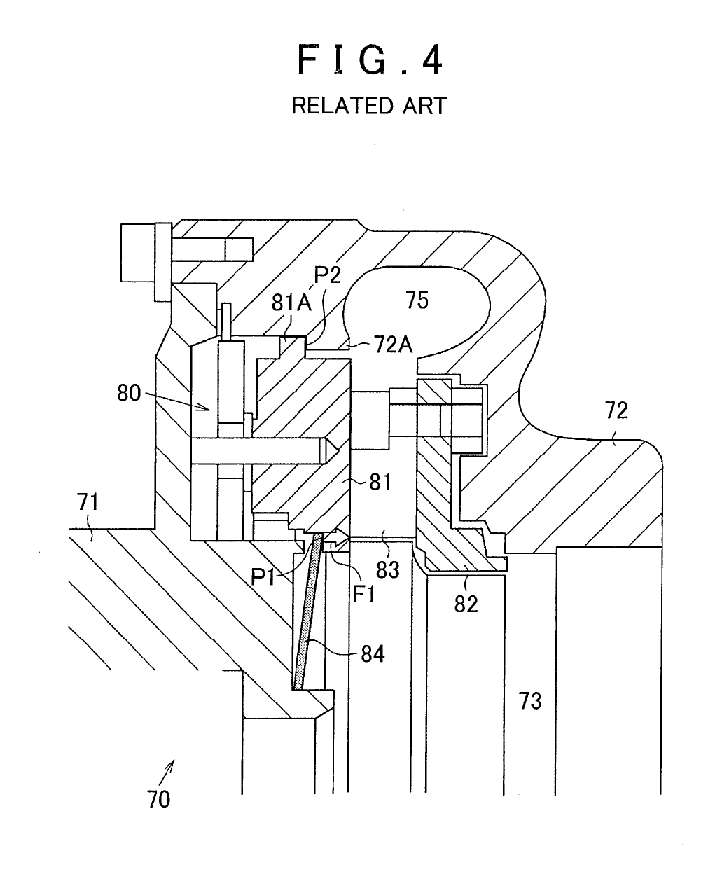

### DETAILED DESCRIPTION OF EMBODIMENTS

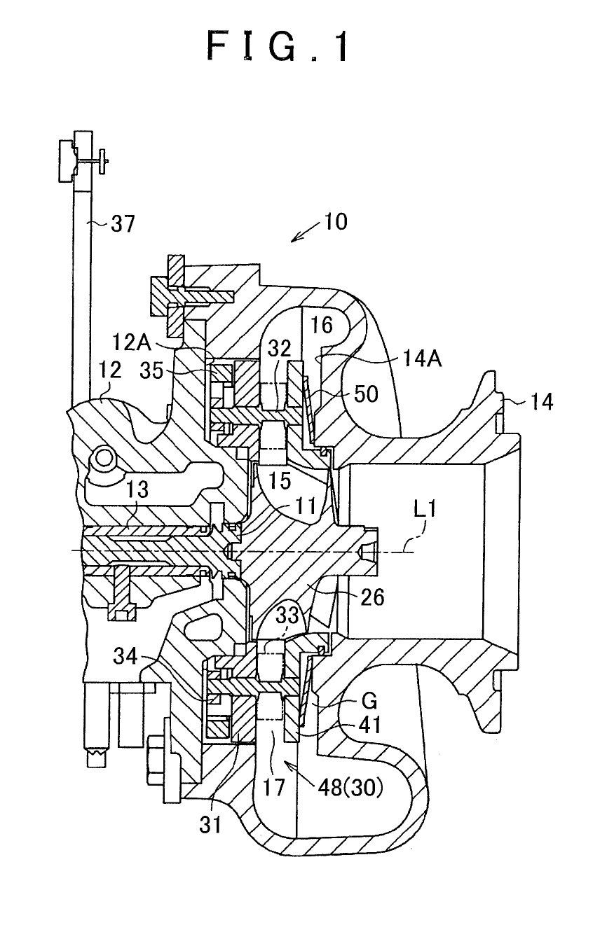

Description is hereinafter made of an embodiment of the present invention with reference to FIG. 1 to FIG. 3. A vehicle is provided with an engine in which a mixture of air that is drawn into combustion chambers through an intake passage and fuel that is supplied into the combustion chambers is burned. This engine is provided with a turbocharger 10 that is shown in FIG. 1. In the turbocharger 10, a turbine shaft 11 is rotatably supported by a bearing housing 12 via a bearing 13. A turbine housing 14 is adjacently disposed on one side (the right side in FIG. 1) of the bearing housing 12 in a direction along the axis L1 of the turbine shaft 11 (which is hereinafter referred to as “axial direction”), and a compressor housing (not shown) which is constituted by a plurality of parts is adjacently located on the other side (the left side in FIG. 1) of the bearing housing 12. The turbine housing 14 and the compressor housing are fixed to the bearing housing 12. The bearing housing 12, the turbine housing 14 and the compressor housing constitute the housing of the turbocharger 10.

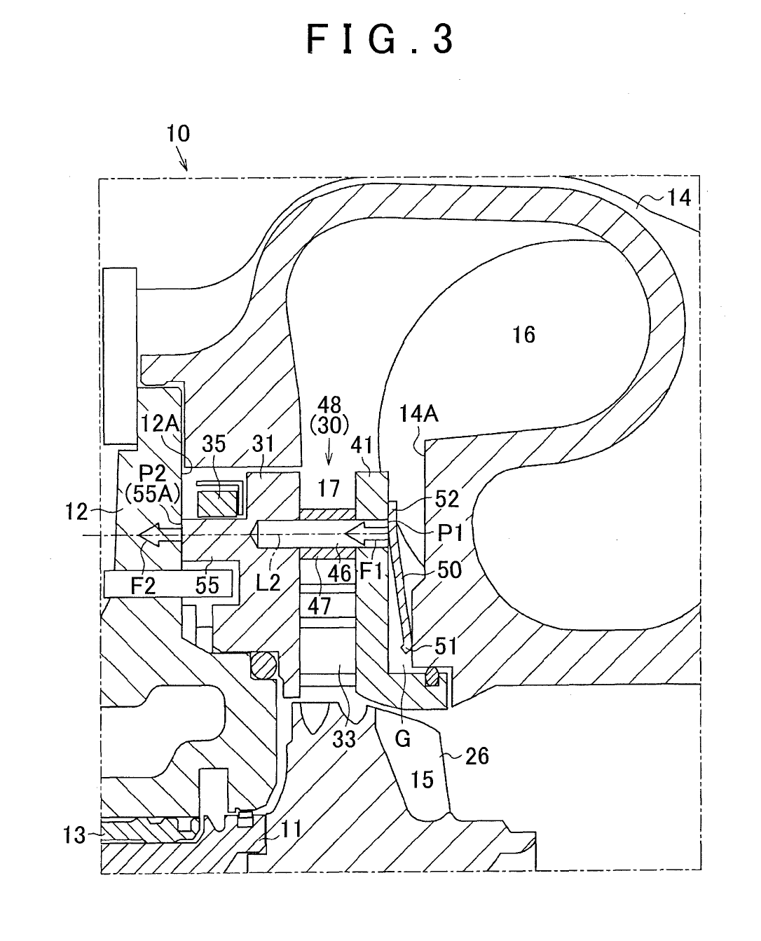

A cylindrical turbine chamber 15 which extends in the axial direction is formed at a central portion of the turbine housing 14. In the turbine housing 14, a scroll passage 16 with a scroll shape is formed around the turbine chamber 15. The turbine chamber 15 and the scroll passage 16 communicate with each other via a communication passage 17 (refer to FIG. 3).

An interior wall face 12A of the bearing housing 12, which faces the communication passage 17, and an interior wall face 14A of the turbine housing 14, which faces the communication passage 17, are both perpendicular, or almost perpendicular, to the axis L1.

A turbine wheel 26 which rotates in the turbine chamber 15 is fixed to one end (the right end in FIG. 1) of the turbine shaft 11. A compressor wheel (not shown) which rotates in the compressor housing is fixed to the other end (the left end in FIG. 1) of the turbine shaft 11.

In the turbocharger 10, which has the above-described basic configuration, exhaust gas that has been discharged from the engine and flowed through the scroll passage 16 is blown onto the turbine wheel 26 through the communication passage 17, so that the turbine wheel 26 is rotated. This rotation is transmitted to the compressor wheel via the turbine shaft 11. As a result, in the engine, the air which is drawn by a negative pressure that is generated in the combustion chambers by the movement of pistons is forcibly fed (supercharged) into the combustion chambers by the rotation of the compressor wheel of the turbocharger 10. In this way, the charging efficiency of air into the combustion chambers is increased.

A variable nozzle mechanism 30 is incorporated in the turbocharger 10. The variable nozzle mechanism 30 changes a flow area in the communication passage 17, through which the exhaust gas flows, to change the flow speed of the exhaust gas that is blown onto the turbine wheel 26, thereby adjusting the rotational speed of the turbocharger 10 to adjust the amount of air that is forcibly fed into the combustion chambers.

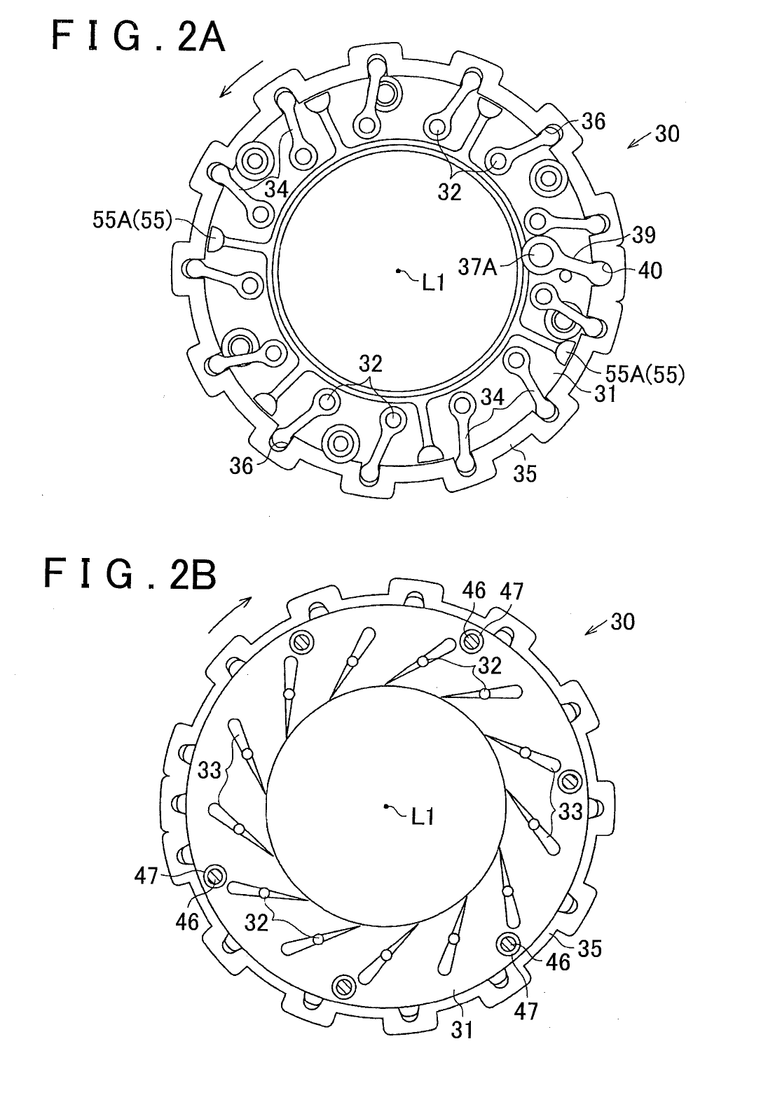

The schematic configuration of the variable nozzle mechanism 30 is next described. FIG. 2A illustrates a part of the variable nozzle mechanism 30 (a nozzle plate 31 and so on) as seen from the left side of FIG. 1, and FIG. 2B illustrates a part of the variable nozzle mechanism 30 (the nozzle plate 31 and so on) as seen from the right side of FIG. 1. As shown in FIG. 1 and FIGS. 2A and 2B, the variable nozzle mechanism 30 includes a nozzle plate 31 and a unison ring 35 which are both located in the communication passage 17. The nozzle plate 31 and the unison ring 35 are annular about the axis L1.

On the nozzle plate 31, a plurality of shafts 32 are arranged at substantially equal angular intervals on a circle around the axis L1. Each shaft 32 is parallel to the axis L1 and extends through the nozzle plate 31 so as to be rotatable. A variable nozzle (nozzle vane) 33 is fixed to one end portion (the right end portion in FIG. 1) of each shaft 32, which protrudes from the nozzle plate 31. In FIG. 1, the variable nozzles 33 are shown by dashed-two dotted lines. The base end of an arm 34 is fixed to the other end portion (the left end portion in FIG. 1) of each shaft 32, which also protrudes from the nozzle plate 31.

The unison ring 35 includes a plurality of recesses 36 that are provided in an inner peripheral surface of the unison ring 35. The distal end portions of the arms 34 are engaged with the recesses 36. The unison ring 35 is rotated from outside the turbocharger 10 via a link 37 (refer to FIG. 1) and so on. Specifically, the link 37 includes a rotating shaft 37A to which an arm 39 is fixed, and the arm 39 has a distal end portion which is engaged with a recess 40 that is formed in an inner peripheral surface of the unison ring 35. When the unison ring 35 is rotated about the axis L1 via the link 37, the rotating shaft 37A, the arm 39 and so on from outside the turbocharger 10, the arms 34, which are engaged with the recesses 36 of the unison ring 35, are rotated (opened or closed) about the shafts 32 in a synchronous manner. The rotation of the shafts 32 changes the opening degree of the variable nozzles 33, so that the flow area in the communication passage 17, through which the exhaust gas flows, is changed. As a result, the flow speed of the exhaust gas that is blown onto the turbine wheel 26 through the spaces between the variable nozzles 33 is adjusted.

For example, when the arm 39 is rotated counterclockwise about the rotating shaft 37A by the link 37 and so on in FIG. 2A, the unison ring 35 is rotated in the direction that is indicated by an arrow in each of FIG. 2A and FIG. 2B. This rotation of the unison ring 35 rotates the shafts 32 counterclockwise in FIG. 2A and clockwise in FIG. 2B. The rotation of the shafts 32 rotates the variable nozzles 33 toward their closed positions, and the flow speed of the exhaust gas which is blown onto the turbine wheel 26 increases. When the variable nozzles 33 are rotated toward their open positions contrary to the above case, the flow speed of the exhaust gas which is blown onto the turbine wheel 26 decreases.

FIG. 3 is an enlarged sectional view that illustrates the sectional structure of a main part of the variable nozzle mechanism 30 in a section different from that of FIG 1 (in a section that passes through a spacer 47, which is described later). As shown in FIG. 1 and FIG. 3, the variable nozzle mechanism 30 includes a shroud plate 41 that is located in the communication passage 17, in addition to the above configuration. The shroud plate 41 is annular about the axis L1. The shroud plate 41 is located on the opposite side (the right side in FIG. 1 and FIG. 3) of the nozzle plate 31 from the bearing housing 12.

An end of each shaft 32 extends through the shroud plate 41 in a manner such that the shaft 32 is rotatable. Thus, the variable nozzles 33 are supported by the nozzle plate 31 and the shroud plate 41 so that the variable nozzles 33 are rotatable together with the shafts 32.

The nozzle plate 31 and the shroud plate 41 are coupled to each other by a plurality of pins 46 as coupling portions to form an “assembly 48.” Each pin 46 is press-fitted in the nozzle plate 31 and the shroud plate 41. The shroud plate 41 and the nozzle plate 31 may be regarded as a pair of plates in the present invention.

The pins 46 are arranged at substantially equal angular intervals on a circle around the axis L1. The diameter of the circle is larger than the diameter of the circle on which the shafts 32 are arranged. Thus, the pins 46 are located farther away from the axis L1 than the shafts 32 are.

Each pin 46 (coupling portion) between the nozzle plate 31 and the shroud plate 41 is covered by the corresponding spacer 47 with a circular tube shape, and a distance substantially equal to the thickness of the variable nozzles 33 is secured between the nozzle plate 31 and the shroud plate 41 by the spacers 47.

In addition, in the turbocharger 10, an urging portion is provided around the turbine wheel 26, in other words, the urging portion is provided in a gap G between the shroud plate 41 of the assembly 48 and the interior wall face 14A of the turbine housing 14. The urging portion is included in the variable nozzle mechanism 30. The urging portion is constituted by a disc spring 50 with an annular shape, which is made of an elastic body, such as a metal plate. The gap G is provided for the purpose of, for example, securing an installation space for the assembly 48 between the bearing housing 12 and the turbine housing 14 even when the turbine housing 14 and so on undergo thermal deformation (expansion or contraction) in high or low temperature conditions or the constituent parts of the turbocharger 10 have variation in accuracy.

The disc spring 50 is provided to urge the assembly 48 in the axial direction and press the assembly 48 against the interior wall face 12A of the bearing housing 12 that is a contacted object. The disc spring 50 has a conical (tapered) shape such that the distance to the interior wall face 14A of the turbine housing 14 decreases toward the center of the disc spring 50.

The disc spring 50 has an inner peripheral edge 51 which is annular about the axis L1 and in contact with the interior wall face 14A of the turbine housing 14. The disc spring 50 has an outer peripheral edge 52 which is annular about the axis L1 and in contact with the shroud plate 41. The diameter of the outer peripheral edge 52 is substantially equal to the diameter of the circle on which the spacers 47 are arranged. Thus, the outer peripheral edge 52 is in contact with the shroud plate 41 at locations corresponding to the spacers 47 (at locations in alignment with the spacers 47).

The disc spring 50 is distorted (elastically deformed) in such a way that its size is reduced in the axial direction by loads that are applied to the inner peripheral edge 51 and the outer peripheral edge 52. The outer peripheral edge 52 of the disc spring 50 urges the assembly 48 (the shroud plate 41) along action lines L2 parallel to the axis L1. The assembly 48 is urged in the axial direction toward the bearing housing 12 by the disc spring 50, so that the nozzle plate 31 is pressed against the interior wall face 12A of the bearing housing 12. The contact of the nozzle plate 31 with the bearing housing 12 enables the assembly 48 to be positioned in the axial direction in a floating manner.

In addition, the assembly 48 of the variable nozzle mechanism 30 includes contact faces which are in contact with the bearing housing 12 at locations on the action lines L2 along which the urging force of the disc spring 50 acts. More specifically, one of the plates 31 and 41 that is located ahead of the other of the plates 31 and 41 in the urging direction in which the disc spring 50 urges the assembly 48 (that is, one of the plates 31 and 41 that is closer to the bearing housing 12 than the other), i.e., the nozzle plate 31, has a plurality of protrusions 55 which protrude forward in the urging direction (refer to FIG. 2A). Note that, it is regarded that the disc spring 50 urges the assembly 48 from a rear side toward a front side, and thus, the nozzle plate 31 is regarded as being located ahead of the shroud plate 41 in the urging direction. The protrusions 55 are arranged on a circle around the axis L1 in such a manner that the protrusions 55 are apart from each other in a circumferential direction. In this embodiment, the circumferential positions of the protrusions 55 are substantially the same as those of the pins 46 and the spacers 47. Thus, the pins 46, the spacers 47 and the protrusions 55 are located on the same straight lines parallel to the axis L1 (on the action lines L2). The protrusions 55 protrude further in the axial direction toward the bearing housing 12 than any other portion of the nozzle plate 31 does. End faces 55A of the protrusions 55 extend perpendicular to the axis L1 at the same position in the axial direction and constitute contact faces which are in contact with the interior wall face 12A of the bearing housing 12.

The variable nozzle mechanism 30 of this embodiment has the above-described configuration. The functions of the variable nozzle mechanism 30 are next described. The exhaust gas which is generated during operation of the engine flows into the turbocharger 10 while flowing through the exhaust passage and then flows through the scroll passage 16 of the turbine housing 14. The exhaust gas flows through the spaces between the variable nozzles 33 and is blown onto the turbine wheel 26 in the turbine chamber 15. The turbine wheel 26 is rotated by the exhaust gas blown onto the turbine wheel 26. Then, the compressor wheel, which is provided on the shaft on which the turbine wheel 26 is provided, is rotated together with the turbine wheel 26 to perform supercharging.

The opening degree of the variable nozzles 33 is changed when the variable nozzles 33 are rotated from outside the turbocharger 10 through operation of the link 37 and so on. Accordingly, the flow speed of the exhaust gas that is blown onto the turbine wheel 26 is changed to change the rotational speed of the turbocharger 10, so that the supercharging pressure of the engine is adjusted.

In the turbocharger 10, the disc spring 50, which is incorporated between the assembly 48 (the shroud plate 41) and the interior wall face 14A of the turbine housing 14, is elastically deformed in the axial direction with elastic energy stored in it.

The shroud plate 41, with which the outer peripheral edge 52 of the disc spring 50 is in contact, is constantly urged in the axial direction by a force which acts to release the elastic energy of the disc spring 50 (elastic restoring force or urging force). The urging force F1 of the disc spring 50 is transmitted to the nozzle plate 31 via the spacers 47 and the pins 46.

In the variable nozzle mechanism 30 (the assembly 48) of this embodiment, the regions P1 to which the urging force F1 of the disc spring 50 is directly applied, the spacers 47 and the pins 46, and the protrusions 55 (the end faces 55A) of the nozzle plate 31 are all located on the action lines L2 along which the urging force F1 of the disc spring 50 acts. Thus, the urging force F1 of the disc spring 50 is transmitted directly to the protrusions 55 via the regions P1, the spacers 47 and the pins 46 along the action lines L2.

When the urging force F1 is transmitted, the assembly 48 is displaced, together with the protrusions 55, toward the bearing housing 12. Then, the end faces 55A of the protrusions 55 as contact faces are pressed against the interior wall face 12A of the bearing housing 12. At this time, because the disc spring 50 has an annular shape and is located to surround the turbine wheel 26, the assembly 48 is urged in the axial direction by the urging force F1 that is substantially equal at any position in the circumferential direction. Thus, the assembly 48 is pressed against the interior wall face 12A of the bearing housing 12 by the pressing force F2 which is substantially equal at any position in the circumferential direction.

In the variable nozzle mechanism 30 of this embodiment, the contact faces, which are in contact with the bearing housing 12 as the contacted object, are located on the action lines L2 along which the urging force F1 of the disc spring 50 acts. Thus, the distance in the radial direction of the turbine shaft 11 between the regions P1 to which the urging force F1 is applied and the regions P2 (the end faces 55A) which are in contact with the bearing housing 12 (the contacted object) is “0.” Thus, because a force (moment) which acts to rotate the variable nozzle mechanism 30 about the regions P2 (the end faces 55A) which are in contact with the bearing housing 12 (the contacted object) is not or hardly applied to the variable nozzle mechanism 30 by the disc spring 50, a load which tends to deform the nozzle plate 31 and the shroud plate 41 is less likely to be applied to the nozzle plate 31 and the shroud plate 41.

The embodiment which has been described in detail above provides the following effects. (1) The nozzle plate 31 and the shroud plate 41 are coupled by the coupling portions (the pins 46) to form the assembly 48. In the variable nozzle mechanism 30, the contact faces (the end faces 55A) of the assembly 48, which are in contact with the contacted object (the bearing housing 12), are located on the action lines L2 along which the urging force F1 of the disc spring 50 acts.

Thus, because the nozzle plate 31 and the shroud plate 41 can be prevented from being deformed by the disc spring 50, the variable nozzles 33 can be prevented from being stuck due to deformation of the nozzle plate 31 or the shroud plate 41.

(2) The assembly 48 is caused to contact the contacted object (the bearing housing 12) and positioned in place only by the urging force F1 of the disc spring 50. In other words, the assembly 48 is not fixed to the housing (the bearing housing 12 or the turbine housing 14) of the turbocharger 10, and is positioned in a floating manner.

Thus, the size of the assembly 48 can be made relatively small and the temperature difference between the constituent parts of the assembly 48 can be made small. Thus, thermal deformation of the assembly 48 at high temperature can be reduced. In addition, because a radially outside portion of the assembly 48, for example, a radially outside portion of the nozzle plate 31, is not forcibly fixed, there is little restraint relating to deformation of the assembly 48. Thus, thermal deformation of the assembly 48 can be reduced.

For the above reasons, even when the gap between the nozzle plate 31 and the variable nozzles 33 or the gap between the shroud plate 41 and the variable nozzles 33 is reduced, problems, such as stiff operation of the variable nozzles 33 at high temperature, are prevented from occurring. The stiff operation of the variable nozzles 33 refers to a phenomenon in which the variable nozzles 33 cannot move smoothly or cannot move at all due to contact between the variable nozzles 33 and the nozzle plate 31 or the shroud plate 41, when they are rotated (opened or closed). As a result, improvement of the turbo performance, in other words, improvement of turbine efficiency can be achieved.

(3) The assembly 48 is urged in the axial direction by the spring (the disc spring 50). Thus, it is possible to provide the urging portion with the simple structure that urges the assembly 48 of the variable nozzle mechanism 30 in the axial direction.

(4) The disc spring 50 is used as the spring as described in (3) above, and the turbine wheel 26 is surrounded by the disc spring 50. Thus, the assembly 48 of the variable nozzle mechanism 30 can be pressed against the contacted object (the bearing housing 12) by the pressing force F2 which is substantially equal at any position in the circumferential direction.

(5) The bearing housing 12 is the contacted object against which the assembly 48 of the variable nozzle mechanism 30 is pressed (i.e., the contacted object with which the assembly 48 is in contact). Because the bearing housing 12, which is an existing constituent part of the turbocharger 10, is used as the contacted object, there is no need to additionally provide a contacted object.

(6) One of the nozzle plate 31 and the shroud plate 41 that is located ahead of the other in the urging direction in which the disc spring 50 urges the assembly 48 (the urging direction of the disc spring 50), i.e., the nozzle plate 31, is provided with the protrusions 55, which protrude forward in the urging direction, and the end faces 55A of the protrusions 55 are used as the contact faces which are in contact with the contacted object. Because the protrusions 55 are provided as described above, the contact faces (the end faces 55A) which are in contact with the contacted object can be reliably positioned on the action lines L2 along which the urging force F1 of the disc spring 50 acts.

(7) The protrusions 55 are arranged on a circle around the axis L1 in a manner such that the protrusions 55 are apart from each other in the circumferential direction. In addition, the end faces 55A of the protrusions 55 are located at the same position in the axial direction. Thus, the assembly 48 (the nozzle plate 31) can be pressed against the interior wall face 12A of the bearing housing 12 by the pressing force F2 which is substantially equal at any position in the circumferential direction.

(8) The spacers 47 are located on the action lines L2, along which the urging force F1 of the disc spring 50 acts. Thus, the urging force F1 of the disc spring 50 can be efficiently transmitted to the bearing housing 12 along the action lines L2 via the regions P1, to which the urging force F1 of the disc spring 50 is directly applied in the variable nozzle mechanism 30, the spacers 47 and the end faces 55A (contact faces) of the protrusions 55.

It should be noted that the present invention can be embodied in other embodiments as described below. The protrusions 55 may be provided on the bearing housing 12, instead of providing the protrusions 55 on the nozzle plate 31.

The urging direction in which the urging portion urges the assembly 48 of the variable nozzle mechanism 30 is not limited to the direction from the turbine housing 14 toward the bearing housing 12 (as in the above embodiment) and may be the direction from the bearing housing 12 toward the turbine housing 14. In this case, the assembly 48 of the variable nozzle mechanism 30 is pressed against the turbine housing 14 instead of being pressed against the bearing housing 12.

A member other than the bearing housing 12 and the turbine housing 14 may be used as the contacted object against which the assembly 48 of the variable nozzle mechanism 30 is pressed. In this case, the contacted object may be an existing constituent part of the turbocharger 10 or may be additionally (newly) provided.

A spring which is different from the disc spring 50 may be used as the urging portion. Alternatively, something different from a spring may be used as the urging portion. While the shafts 32 extend through both the nozzle plate 31 and the shroud plate 41 in the above embodiment, the shafts 32 may extend through only the nozzle plate 31.

The protrusions 55 may be arranged at circumferential positions different from the circumferential positions at which the spacers 47 are located on a circle around the axis L1 of the turbine shaft 11. As the coupling portion that couples the nozzle plate 31 and the shroud plate 41, something different from the pins 46 may be used. For example, either the nozzle plate 31 or the shroud plate 41 may be provided with a coupling portion. In this case, the coupling portion may be formed integrally with the nozzle plate 31 or the shroud plate 41.

1. A variable nozzle mechanism which is applied to a turbocharger that includes a bearing housing by which a turbine shaft is rotatably supported; a turbine housing which is located on one side of the bearing housing in a direction along an axis of the turbine shaft and which includes a turbine chamber and a scroll passage provided around the turbine chamber; and a turbine wheel which is mounted on the turbine shaft and rotates in the turbine chamber of the turbine housing, wherein exhaust gas that has been discharged from an engine and flowed through the scroll passage is blown onto the turbine wheel so that the turbine wheel is rotated,
the variable nozzle mechanism comprising:
a pair of annular plates located between the scroll passage and the turbine chamber in a manner such that the plates are apart from each other in the direction along the axis;
a coupling portion which couples the plates;
a plurality of variable nozzles which are provided between the plates so as to open and close, and which change a flow speed of the exhaust gas blown onto the turbine wheel when an opening degree of the variable nozzles is changed; and
an urging portion which urges the plates in the direction along the axis to press one of the plates against a contacted object,
wherein the one of the plates includes a contact face which is in contact with the contacted object, and the contact face is located on an action line along which an urging force of the urging portion acts.

2. The variable nozzle mechanism according to claim 1, wherein the urging portion is a spring.

3. The variable nozzle mechanism according to claim 2, wherein the spring is a disc spring which is provided to surround the turbine wheel.

4. The variable nozzle mechanism according to claim 1, wherein the contacted object is the bearing housing or the turbine housing.

5. The variable nozzle mechanism according to claim 1, wherein the one of the plates is located ahead of the other of the plates in an urging direction of the urging portion, the one of the plates includes a protrusion which protrudes forward in the urging direction, and an end face of the protrusion constitutes the contact face.

6. The variable nozzle mechanism according to claim 1, further comprising a spacer which is located between the plates and on the action line passing through the contact face, to maintain a distance between the plates.

7. The variable nozzle mechanism according to claim 6, wherein the coupling portion is located on the action line passing through the contact face, and the coupling portion is covered by the spacer.
